(19) United States
(12) Patent Application Publication
(10) Pub. No.: US 2020/0193633 A1
(43) Pub. Date: Jun. 18, 2020

(54) IMAGE PROCESSING DEVICE AND IMAGE PROCESSING METHOD

(71) Applicant: DENSO TEN Limited, Kobe-shi (JP)

(72) Inventors: Yuichi SUGIYAMA, Kobe-shi (JP); Wataru HASEGAWA, Kobe-shi (JP)

(73) Assignee: DENSO TEN Limited, Kobe-shi (JP)

(21) Appl. No.: 16/693,764

(22) Filed: Nov. 25, 2019

(30) Foreign Application Priority Data
Dec. 13, 2018 (JP) 2018-233842
Aug. 8, 2019 (JP) 2019-146750

(51) Int. Cl. G06T 7/73; G06T 7/00

(52) U.S. Cl. CPC G06T 7/73; G06T 7/97; H04N 5/247; G06T 2207/30244; G06T 2207/30252; G06T 2207/10016

(57) ABSTRACT

An image processing device includes position estimation, position difference calculation, and image-capturing time lag detection units. The position estimation unit respectively estimates self-positions of a plurality of cameras that are mounted on a movable body and capture images of a periphery of the movable body. The position difference calculation unit calculates, as a position difference, a difference between a first self-position of a camera that is estimated at a first point of time before the movable body is accelerated or decelerated to move and a second self-position of the camera that is estimated at a second point of time when the movable body is accelerated or decelerated to move. The image-capturing time lag detection unit detects an image-capturing time lag that indicates a lag of image-capturing time of an image among the plurality of cameras based on the position difference that is calculated by the position difference calculation unit.

### CROSS-REFERENCE TO RELATED APPLICATIONS

The present application claims the benefit of priority to Japanese Patent Application No. 2018-233842 filed on Dec. 13, 2018 and Japanese Patent Application No. 2019-146750 filed on Aug. 8, 2019, the entire contents of which patent applications are incorporated by reference in the present application.

### FIELD

A disclosed embodiment relates to an image processing device and an image processing method.

### BACKGROUND

An image processing device has conventionally been proposed where a camera is mounted on a movable body such as a vehicle, and for example, estimation of a self-position of the camera or the like is executed based on an image of a periphery of the movable body that is obtained from the camera (see, for example, Japanese Patent Application Publication No. 2017-207942).

Meanwhile, for example, in a case where a plurality of cameras are mounted on a movable body, an image processing device according to a conventional technique may integrate information of images that are captured by respective cameras to create map information of a periphery of the movable body.

However, among a plurality of cameras, image-capturing times (image-capturing timings) are different from one another, so that degradation of accuracy of map information that is created in an image processing device may be caused. That is, a lag of image-capturing time is provided among a plurality of cameras, so that, for example, in a case where a movable body is moving, a position of the movable body at a time when an image is captured by a first camera among the plurality of cameras is different from a position of the movable body at a time when an image is captured by a next camera, and as a result, a positional shift is caused in information of images that are obtained from respective cameras. As information of images is integrated to create map information while such a positional shift is caused, degradation of accuracy of the map information may be caused.

Hence, if it is possible to detect a lag of image-capturing time among a plurality of cameras, it is possible to improve accuracy of map information by correcting a positional shift of information of images based on, for example, the lag of image-capturing time, or the like. Therefore, it is desired that a lag of image-capturing time among a plurality of cameras that are mounted on a movable body is detected.

### SUMMARY

An image processing device according to an aspect of an embodiment includes a position estimation unit, a position difference calculation unit, and an image-capturing time lag detection unit. The position estimation unit respectively estimates self-positions of a plurality of cameras that are mounted on a movable body and capture images of a periphery of the movable body. The position difference calculation unit calculates, as a position difference, a difference between a first self-position of a camera that is estimated at a first point of time before the movable body is accelerated or decelerated to move and a second self-position of the camera that is estimated at a second point of time when the movable body is accelerated or decelerated to move. The image-capturing time lag detection unit detects an image-capturing time lag that indicates a lag of image-capturing time of an image among the plurality of cameras based on the position difference that is calculated by the position difference calculation unit.

### BRIEF DESCRIPTION OF DRAWINGS

More complete recognition of the present invention and an advantage involved therewith could readily be understood by reading the following detailed description of the invention in light of the accompanying drawings.

FIG. 1A is a diagram illustrating an image processing system that includes an image processing device according to a first embodiment.

FIG. 1B is a diagram illustrating an outline of an image processing method.

FIG. 2 is a block diagram illustrating a configuration example of an image processing system that includes an image-processing device according to a first embodiment.

FIG. 3 is a flowchart illustrating process steps that are executed by an image processing device.

FIG. 4 is a block diagram illustrating a configuration example of an image processing system that includes an image-processing device according to a second embodiment.

FIG. 5 is a diagram for explaining an image processing device according to a second embodiment.

FIG. 6 is a flowchart illustrating process steps that are executed by an image processing device according to a second embodiment.

FIG. 7 is a diagram for explaining an image processing method according to a third embodiment.

FIG. 8 is a flowchart illustrating process steps that are executed by an image processing device according to a third embodiment.

### DESCRIPTION OF EMBODIMENTS

### First Embodiment

1. Outline of Image Processing Device and Image Processing Method

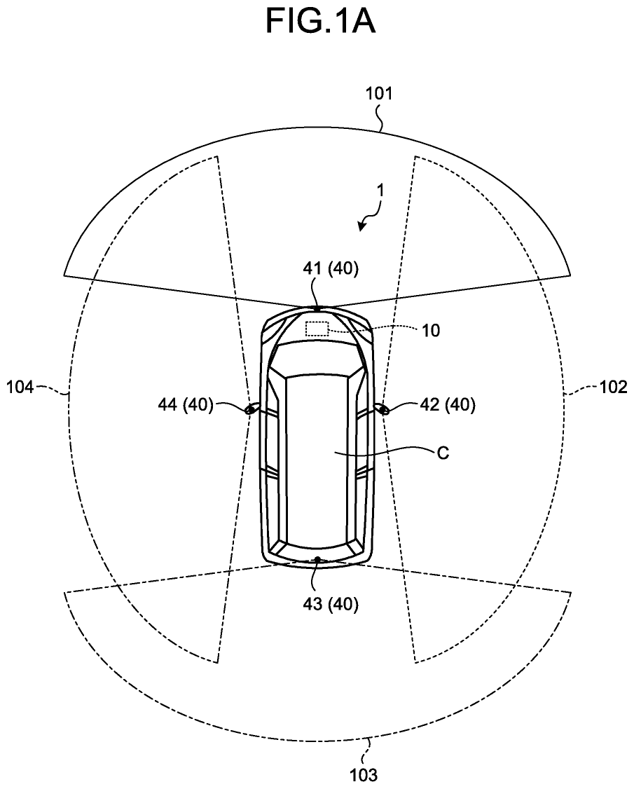

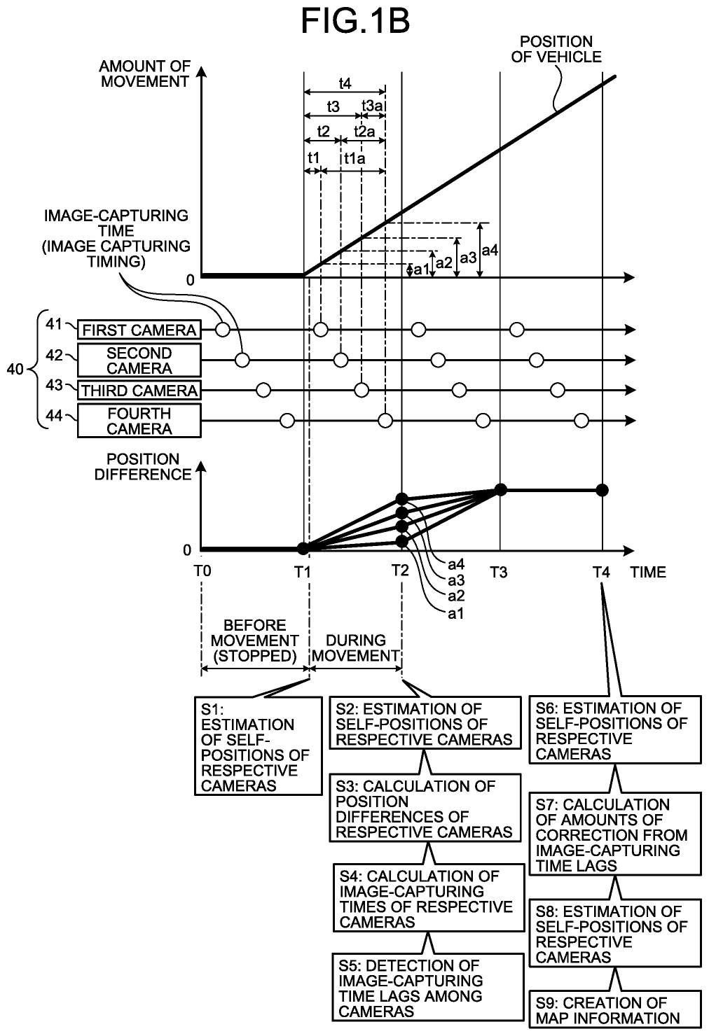

Hereinafter, first, an outline of an image processing device and an image processing method according to a first embodiment will be explained with reference to FIG. 1A and FIG. 1B. FIG. 1A is a diagram illustrating an image processing system that includes an image processing device according to a first embodiment and FIG. 1B is a diagram illustrating an outline of an image processing method.

As illustrated in FIG. 1A, an image processing system 1 according to a first embodiment includes an image processing device 10 and a plurality of cameras 40. Such an image processing device 10 and a plurality of cameras 40 are mounted on a vehicle C.

Additionally, such a vehicle C is an example of a movable body. Furthermore, although the image processing device 10 and the plurality of cameras 40 are mounted on such a vehicle C (herein, a car) in the above, this is not limiting and it may be mounted on another type of movable body as long as it is a movable body capable of moving such as, for example, a motorcycle, a mobile robot, or a mobile vacuum cleaner.

Although the number of the plurality of cameras 40 is, for example, four, this is not limiting and it may be two, three, or five or more. Furthermore, the plurality of cameras 40 include a first camera 41, a second camera 42, a third camera 43, and a fourth camera 44.

The first camera 41 is arranged on a front side of a vehicle C. Furthermore, the second camera 42 is arranged on a right side of the vehicle C, the third camera 43 is arranged on a back side of the vehicle C, and the fourth camera 44 is arranged on a left side of the vehicle C. Additionally, arrangement of the first to fourth cameras 41 to 44 on the vehicle C as illustrated in FIG. 1A is merely illustrative and is not limiting. Furthermore, hereinafter, in a case where the first to fourth cameras 41 to 44 are explained without particular distinction, “a camera(s) 40” will be described.

A camera 40 includes, for example, an image-capturing element such as a Charge Coupled Device (CCD) or a Complementary Metal Oxide Semiconductor (CMOS) and captures an image of a periphery of a vehicle C by using such an image-capturing element. Specifically, the first camera 41, the second camera 42, the third camera 43, and the fourth camera 44 capture an image of a front side of a vehicle C, an image of a right side of the vehicle C, an image of a back side of the vehicle C, and an image of a left side of the vehicle C, respectively.

Furthermore, a camera 40 includes, for example, a wide-angle lens such as a fish-eye lens, and hence, has a comparatively wide angle of view. Therefore, it is possible to capture an image of a complete periphery of a vehicle C by utilizing such a camera 40. Additionally, FIG. 1A illustrates a range where an image is captured by the first camera 41 as a “first image-capturing range 101”. Similarly, a range where an image is captured by the second camera 42 is illustrated as a “second image-capturing range 102”, a range where an image is captured by the third camera 43 is illustrated as a “third image-capturing range 103”, and a range where an image is captured by the fourth camera 44 is illustrated as a “fourth image-capturing range 104”.

Each of the plurality of cameras 40 outputs information of captured images to the image processing device 10. The image processing device 10 may integrate information of images that are captured by the plurality of cameras 40 to create map information of a periphery of a vehicle C. Additionally, although such map information is, for example, map information that includes information regarding a target or an obstacle that is present around a vehicle C or the like, this is not limiting. Furthermore, map information as described above is also referred to as information that indicates a positional relationship with a target or an obstacle that is present around its own vehicle (a vehicle C).

The image processing device 10 may create vehicle position information that indicates a position of a vehicle C based on self-positions of the plurality of cameras 40 that are obtained from information of images that are captured by the plurality of cameras 40 where this will be described later. Additionally, vehicle position information is an example of mobile body position information. Furthermore, vehicle position information may be included in map information as described above.

Meanwhile, image-capturing times among the plurality of cameras 40 as described above are different from one another, so that degradation of accuracy of map information that is created may be caused in a conventional technique. This will be explained with reference to FIG. 1B.

FIG. 1B illustrates an amount of movement of a vehicle C on an upper section, illustrates a time to capture an image (an image-capturing time or capturing timing) in a camera 40 on a middle section, and illustrates a position difference of the camera 40 (as described later) on a lower section. Furthermore, points of time T0 to T4 as illustrated in FIG. 1B are operation timings to execute an operation in the image processing device 10. Additionally, an image-capturing time herein is a period of time from a certain reference timing (for example, an operation timing T1 of the image processing device 10) to a timing when a camera 40 captures an image.

Additionally, FIG. 1B illustrates a case where a stopped vehicle C is started, that is, starts to move after a point of time T1. Furthermore, although an example of FIG. 1B illustrates that image-capturing is executed in order of the first camera 41, the second camera 42, the third camera 43, and the fourth camera 44, such an order of image-capturing is merely illustrative and is not limiting.

As illustrated in FIG. 1B, lags of image-capturing time are present among the first to fourth cameras 41 to 44, so that, for example, in a case where a vehicle C is moving, a position of the vehicle C at a time when an image is captured by a first camera 40 (herein, the first camera 41) and a position of the vehicle C at a time when an image is captured by a next camera 40 (herein, the second camera 42) are different. Hence, positional shifts are caused in information of images that are obtained from respective cameras 40, and as information of images is integrated to create map information while such positional shifts are caused, degradation of accuracy of the map information may be caused.

Hence, the image processing device 10 according to the present embodiment is configured in such a manner that it is possible to detect a lag(s) of image-capturing time among the plurality of cameras 40. Furthermore, in the present embodiment, a positional shift(s) of information of images is/are corrected based on a detected lag(s) of image-capturing time so as to improve accuracy of map information.

As is explained specifically, the image processing device 10 respectively acquires information of images from the first to fourth cameras 41 to 44 at a point of time T1 and estimates self-positions of the first to fourth cameras 41 to 44 based on acquired information of images (step S1). For example, the image processing device 10 acquires information of images that are captured by the first to fourth cameras 41 to 44 between points of time T0 to T1. Then, the image processing device 10 applies, for example, a Simultaneous Localization And Mapping (SLAM) technique to acquired information of images, so that it is possible to estimate self-positions of the first to fourth cameras 41 to 44.

Additionally, a vehicle C starts to move after a point of time T1, so that, at step S1, the image processing device 10 estimates self-positions of the first to fourth cameras 41 to 44 before the vehicle C is accelerated to move. Furthermore, a point of time T1 is an example of a first point of time and self-positions of the first to fourth cameras 41 to 44 that are estimated at the period of time T1 are examples of a first self-position.

Herein, as a position difference of a camera 40 as illustrated in a lower section of FIG. 1B is explained, such a position difference is a difference between a self-position of a camera 40 that is estimated in a previous process and a self-position of a corresponding camera 40 that is estimated in a current process. Specifically, as the first camera 41 is provided as an example, a position difference of the first camera 41 is a difference between a self-position of the first camera 41 that is estimated in a previous process and a self-position of the first camera 41 that is estimated in a current process. Therefore, the first camera 41 is mounted on a vehicle C and such a vehicle C is stopped at a point of time T1 in FIG. 1B, so that a position difference that is a difference between a self-position of the first camera 41 that is estimated at a point of time T0 in a previous process and a self-position of the first camera 41 that is estimated at a point of time T1 in a current process is zero. Additionally, position differences of the second to fourth cameras 42 to 44 are also zero, similarly to the first camera 41, so that position differences of the first to fourth cameras 41 to 44 are illustrated so as to be superimposed at a point of time T1 in FIG. 1B.

Additionally, the image processing device 10 monitors position differences of such first to fourth cameras 41 to 44 and when they are not zero or when such position differences are different values among the first to fourth cameras 41 to 44, a process to detect lags of image-capturing time or the like is executed where this will be described later.

Then, the image processing device 10 respectively acquires information of images from the first to fourth cameras 41 to 44 at a point of time T2 and estimates self-positions of the first to fourth cameras 41 to 44 based on acquired information of images (step S2). For example, the image processing device 10 acquires information of images that are captured by the first to fourth cameras 41 to 44 between points of time T1 to T2 and estimates self-positions of the first to fourth cameras 41 to 44.

Herein, a vehicle C starts to move after a point of time T1, so that the image processing device 10 at step S2 estimates self-positions of the first to fourth cameras 41 to 44 at a time when the vehicle C is accelerated to move. Additionally, a point of time T2 when a vehicle C is moving is an example of a second point of time and self-positions of the first to fourth cameras 41 to 44 that are estimated at point of time T2 are examples of a second self-position.

Then, the image processing device 10 calculates position differences of the first to fourth cameras 41 to 44 (step S3). As described above, the image processing device 10 calculates, as position differences of the first to fourth cameras 41 to 44, differences between self-positions of the first to fourth cameras 41 to 44 that are estimated in a previous process (herein, a process at a point of time T1) and self-positions of the corresponding first to fourth cameras 41 to 44 that are estimated in a current process (herein, a process at a point of time T2).

In other words, the image processing device 10 calculates, as position differences, differences between self-positions of the first to fourth cameras 41 to 44 that are estimated before a vehicle C is accelerated to move and those of the first to fourth cameras 41 to 44 that are estimated at a time when the vehicle C is accelerated to move.

Specifically, the image processing device 10 calculates, as a position difference of the first camera 41, a difference a1 between a self-position of the first camera 41 that is estimated in a process at a point of time T1 and a self-position of the first camera 41 that is estimated at a process at a point of time T2. Furthermore, the image processing device 10 calculates, as a position difference of the second camera 42, a difference a2 between a self-position of the second camera 42 that is estimated in a process at a point of time t1 and a self-position of the second camera 42 that is estimated in a process at a point of time T2.

Furthermore, the image processing device 10 calculates, as a position difference of the third camera 43, a difference a3 between a self-position of the third camera 43 that is estimated in a process at a point of time T1 and a self-position of the third camera 43 that is estimated in a process at a point of time T2. Furthermore, the image processing device 10 calculates, as a position difference of the fourth camera 44, a difference a4 between a self-position of the fourth camera 44 that is estimated in a process at a point of time T1 and a self-position of the fourth camera 44 that is estimated in a process at a point of time T2.

Herein, calculated position differences of the first to fourth cameras 41 to 44 are not zero, so that the image processing device 10 executes a process to detect lags of image-capturing time or the like. Specifically, the image processing device 10 respectively calculates image-capturing times of images in the first to fourth cameras 41 to 44 based on calculated position differences of the first to fourth cameras 41 to 44 (step S4).

More specifically, the image processing device 10 respectively divides calculated position differences of the first to fourth cameras 41 to 44 by a speed at a time when a vehicle C is moving to calculate image-capturing times of images in the first to fourth cameras 41 to 44, respectively.

For example, the image processing device 10 divides a position difference of the first camera 41 by a speed of a vehicle C to calculate an image-capturing time t1 of an image in the first camera 41. Furthermore, the image processing device 10 divides a position difference of the second camera 42 by a speed of a vehicle C to calculate an image-capturing time t2 of an image in the second camera 42.

Furthermore, the image processing device 10 divides a position difference of the third camera 43 by a speed of a vehicle C to calculate an image-capturing time t3 of an image in the third camera 43. Furthermore, the image processing device 10 divides a position difference of the fourth camera 44 by a speed of a vehicle C to calculate an image-capturing time t4 of an image in the fourth camera 44.

Additionally, a speed of a vehicle C that is used for calculation of an image-capturing time as described above may be a speed that is estimated in a next operation process (herein, at a point of time T3) as described later or may be a speed that is obtained from a non-illustrated vehicle speed sensor.

Then, the image processing device 10 detects image-capturing time lags that indicate lags of image-capturing time of images among the plurality of cameras 40, that is, among the first to fourth cameras 41 to 44 (step S5).

Hereinafter, a case where an image-capturing time lag(s) is/are detected with respect to an image-capturing time t4 of an image of the fourth camera 44 will be explained as an example. For example, the image processing device 10 detects a time difference t1a that is obtained by subtracting an image-capturing time t1 of the first camera 41 from an image-capturing time t4 of the fourth camera 44, as an image-capturing time lag t1a of the first camera 41 with respect to the fourth camera 44.

Furthermore, the image processing device 10 detects a time difference t2a that is obtained by subtracting an image-capturing time t2 of the second camera 42 from an image-capturing time t4 of the fourth camera 44, as an image-capturing time lag t2a of the second camera 42 with respect to the fourth camera 44. Furthermore, the image processing device 10 detects a time difference t3a that is obtained by subtracting an image-capturing time t3 of the third camera 43 from an image-capturing time t4 of the fourth camera 44, as an image-capturing time lag t3a of the third camera 43 with respect to the fourth camera 44.

Additionally, although an image-capturing time lag is detected with respect to an image-capturing time t4 of the fourth camera 44 in the above, this is not limiting, and for example, any one of image-capturing times t1 to t3 of the first to third cameras 41 to 43 may be a reference, and any predetermined time such as, for example, a point of time T2 may be a reference.

In the present embodiment, a difference between a self-position of a camera 40 that is estimated before a vehicle C is accelerated to move and a self-position of the camera 40 that is estimated at a time when the vehicle C is accelerated to move is calculated as a position difference. In other words, in the present embodiment, a position difference of a camera 40 is calculated at a timing when position differences are different among the plurality of cameras 40, specifically, a timing before or after a vehicle C is accelerated to move and when a lag of image-capturing time is caused.

Thereby, in the present embodiment, calculated position differences are different among the plurality of cameras 40, so that it is possible to detect image-capturing time lags among the plurality of cameras 40 by using such position differences.

As described above, as image-capturing time lags among the plurality of cameras 40 are detected, the image processing device 10 executes a correction process to correct positional shifts of information of images by using detected image-capturing time lags or the like.

In an example as illustrated in FIG. 1B, a case where a correction process or the like is executed at a point of time T4 will be explained as an example. The image processing device 10 respectively acquires information of images from the first to fourth cameras 41 to 44 at a point of time T4 and estimates self-positions of the first to fourth cameras 41 to 44 based on acquired information of images (step S6). For example, the image processing device 10 acquires information of images that are captured by the first to fourth cameras 41 to 44 between points of time T3 to T4. Additionally, such information of images includes positional shifts that are caused by image-capturing time lags among the plurality of cameras 40.

Then, the image processing device 10 multiplies image-capturing time lags that are detected at step S5 by a current speed of a vehicle C to calculate amounts of correction of self-positions of respective cameras 40 (step S7).

For example, the image processing device 10 multiplies an image-capturing time lag t1a of the first camera 41 with respect to the fourth camera 44 by a current speed of a vehicle C to calculate an amount of correction of a self-position of the first camera 41. Furthermore, the image processing device 10 multiplies an image-capturing time lag t2a of the second camera 42 with respect to the fourth camera 44 by a current speed of a vehicle C to calculate an amount of correction of a self-position of the second camera 42.

Furthermore, the image processing device 10 multiplies an image-capturing time lag t3a of the third camera 43 with respect to the fourth camera 44 by a current speed of a vehicle C to calculate an amount of correction of a self-position of the third camera 43. Additionally, in an example as illustrated in FIG. 1B, the fourth camera 44 is a reference for calculating an image-capturing time lag, so that an amount of correction of a self-position of the fourth camera 44 is zero.

Additionally, for example, a current speed of a vehicle C that is used for calculation of an amount of correction as described above may be a current speed that is estimated in an operation process at a point of time T4 or may be a current speed that is obtained from a non-illustrated vehicle speed sensor. In a case where a current speed is estimated in an operation process, the image processing device 10 first calculates a position difference of a camera 40. A position difference of a camera 40 is a difference between self-positions of the camera 40 that are estimated in a previous process and a current process, so that the image processing device 10 divides a calculated position difference by a period of time from the previous process to the current process (herein, a frame time of a point of time T3 to a point of time T4) and thereby it is possible to estimate a current speed of a vehicle C.

Then, the image processing device 10 corrects self-positions of the first to fourth cameras 41 to 44 that are estimated at step S6 based on amounts of correction that are calculated at step S7 (step S8). For example, the image processing device 10 adds an amount of correction of a self-position of the first camera 41 to an estimated self-position of the first camera 41 to correct the estimated self-position of the first camera 41. Thereby, a self-position of the first camera 41 is a position that is synchronized with a self-position of the fourth camera 44, so that it is possible to reduce an influence of a positional shift that is caused by an image-capturing time lag t1a between the first camera 41 and the fourth camera 44.

Furthermore, the image processing device 10 adds an amount of correction of a self-position of the second camera 42 to an estimated self-position of the second camera 42 to correct the estimated self-position of the second camera 42. Thereby, a self-position of the second camera 42 is a position that is synchronized with a self-position of the fourth camera 44, so that it is possible to reduce an influence of a positional shift that is caused by an image-capturing time lag t2a between the second camera 42 and the fourth camera 44.

Furthermore, the image processing device 10 adds an amount of correction of a self-position of the third camera 43 to an estimated self-position of the third camera 43 to correct the estimated self-position of the third camera 43. Thereby, a self-position of the third camera 43 is a position that is synchronized with a self-position of the fourth camera 44, so that it is possible to reduce an influence of a positional shift that is caused by an image-capturing time lag t3a between the third camera 43 and the fourth camera 44.

Then, the image processing device 10 integrates information of images that are captured by the plurality of cameras 40 based on a corrected self-position of the camera 40 to create map information around a vehicle C (step S9).

Thus, in the present embodiment, a self-position of a camera 40 where an influence of a positional shift that is caused by an image-capturing time lag among the plurality of cameras 40 is reduced by correction with an amount of correction as described above is used, so that it is possible to improve accuracy of map information that is created.

Furthermore, for example, an automated car parking apparatus that parks a vehicle C by automated driving or the like in a comparatively large parking space of a commercial facility or the like, a small parking space of a standard household or the like, or the like, may control the vehicle C by using map information around the vehicle C. In such a case, map information with high accuracy that is created by the image processing device 10 according to the present embodiment is used, so that it is possible for an automated car parking apparatus or the like to control a vehicle C accurately, and as a result, it is possible to automatically park the vehicle C appropriately.

Furthermore, although map information is used in parking control of a vehicle C in a parking space that uses automated driving control (automated parking control that includes a so-called automatic valet parking) in the above, vehicle position information that indicates a position of such a vehicle C may be used instead thereof or in addition thereto. Also in such a case, it is possible to automatically park a vehicle C appropriately.

As is explained specifically, arrangement or a position of a camera 40 on a vehicle C is set preliminarily, so that it is possible for the image processing device 10 to create vehicle position information that indicates a position of the vehicle C based on a corrected self-position of the camera 40. Thus, in the present embodiment, a self-position of a camera 40 where an influence of a positional shift that is caused by an image-capturing time lag among the plurality of cameras 40 is reduced by correction with an amount of correction as described above is used, so that it is possible to improve accuracy of vehicle position information that is created. Then, in the present embodiment, created vehicle position information with high accuracy is used, so that it is possible for an automated car parking apparatus or the like to control a vehicle C accurately, and as a result, it is possible to automatically park the vehicle C appropriately.

2. Configuration of Image Processing System that Includes Image Processing Device

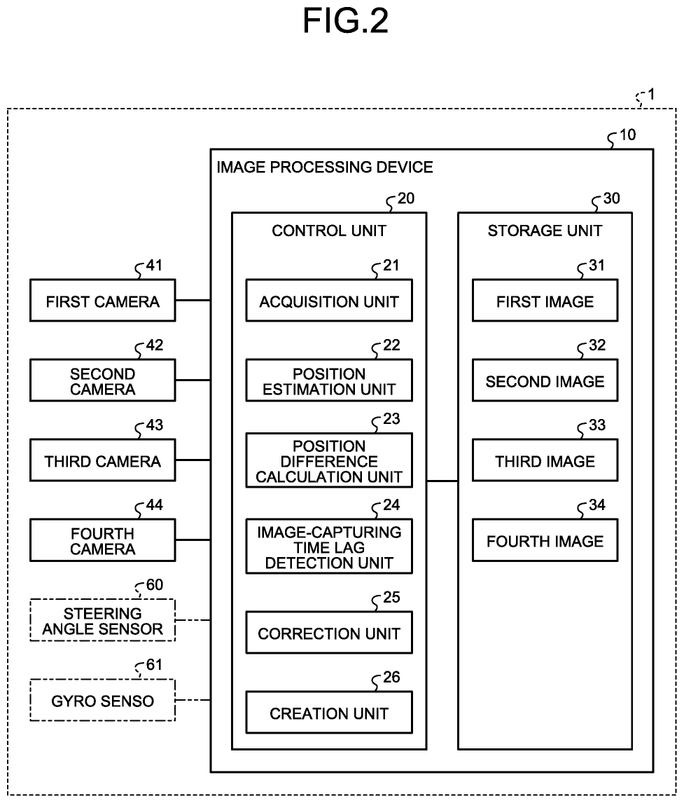

Next, a configuration of an image processing system 1 that includes an image processing device 10 according to the present embodiment will be explained by using FIG. 2. FIG. 2 is a block diagram illustrating a configuration example of the image processing system 1 that includes the image processing device 10 according to a first embodiment. Additionally, a block diagram such as FIG. 2 illustrates only a component(s) that is/are needed to explain a feature of the present embodiment as a functional block(s) and omits a description(s) for a general component(s).

In other words, each component that is illustrated in a block diagram such as FIG. 2 is functionally conceptual and does not have to be physically configured as illustrated in such a diagram. For example, a specific form of dispersion or integration of respective blocks is not limited to those as illustrated in such a diagram and it is possible to disperse or integrate all or a part thereof functionally or physically in any unit depending on various types of loads, usage, or the like to provide a configuration.

As illustrated in FIG. 2, the image processing system 1 includes the image processing device 10 and the first to fourth cameras 41 to 44 as described above. The first to fourth cameras 41 to 44 respectively output information of images that are captured thereby to the image processing device 10.

The image processing device 10 includes a control unit 20 and a storage unit 30. The storage unit 30 is a storage unit that is composed of a storage device such as a non-volatile memory or a hard disk drive. The storage unit 30 stores a first image 31, a second image 32, a third image 33, a fourth image 34, various types of programs, setting data, and the like.

A first image 31 is information of an image that is captured by the first camera 41. Furthermore, a second image 32, a third image 33, and a fourth image 34 are information of images that are captured by the second camera 42, the third camera 43, and the fourth camera 44, respectively. Additionally, information of images that are included in first to fourth images 31 to 34 may be singular or plural.

The control unit 20 includes an acquisition unit 21, a position estimation unit 22, a position difference calculation unit 23, an image-capturing time lag detection unit 24, a correction unit 25, and a creation unit 26, and is a microcomputer that has a Central Processing Unit (CPU) or the like.

The acquisition unit 21 acquires information of images that are output from the first to fourth cameras 41 to 44. Then, the acquisition unit 21 stores information of an image that is output from the first camera 41, as a first image 31, in the storage unit 30. Furthermore, the acquisition unit 21 stores information of an image that is output from the second camera 42, as a second image 32, in the storage unit 30. Furthermore, the acquisition unit 21 stores information of an image that is output from the third camera 43, as a third image 33, in the storage unit 30, and stores information of an image that is output from the fourth camera 44, as a fourth image 34, in the storage unit 30.

The position estimation unit 22 respectively estimates self-positions of the first to fourth cameras 41 to 44. For example, the position estimation unit 22 accesses the storage unit 30 to read a first image 31 and applies an SLAM technique to the first image 31 to estimate a self-position of the first camera 41. Similarly, the position estimation unit 22 sequentially reads second to fourth images 31 to 34 and estimates self-positions of the second to fourth cameras 42 to 44 based on the second to fourth images 32 to 34. Additionally, although self-positions of the first to fourth cameras 41 to 44 as described above are, for example, coordinate values, this is not limiting.

The position difference calculation unit 23 calculates position differences of the first to fourth cameras 41 to 44. For example, the position difference calculation unit 23 calculates, as position differences, differences between self-positions of the first to fourth cameras 41 to 44 that are estimated in a previous process and self-positions of the first to fourth cameras 41 to 44 that are estimated in a current process.

Herein, for example, in a case where a vehicle C is stopped in both a previous process and a current process, self-positions of the first to fourth cameras 41 to 44 are not changed, so that position differences of the first to fourth cameras 41 to 44 that are calculated by the position difference calculation unit 23 are zero (see a point of time T1 in FIG. 1B).

Furthermore, for example, in a case where speeds of vehicle C in both a previous process and a current process are identical or substantially identical, that is, such a vehicle C is moving at a constant speed, position differences among the first to fourth cameras 41 to 44 that are calculated by the position difference calculation unit 23 are identical values or substantially identical values (see a point of time T3 or T4 in FIG. 1B).

On the other hand, in a case where speeds of a vehicle C in a previous process and a current process are different, for example, in a case where such a vehicle C is started from a stopped state so as to start to move, position differences among the first to fourth cameras 41 to 44 that are calculated by the position difference calculation unit 23 are different values, in other words, are not zero (see point of time T2 in FIG. 1B).

Then, in a case where detection is executed in such a manner that position differences among the first to fourth cameras 41 to 44 are difference values or a case where detection is executed in such a manner that they are not zero, the position difference calculation unit 23 outputs information that indicates calculated position differences to the image-capturing time lag detection unit 24 where a process to detect image-capturing time lags or the like is executed.

Thus, it is possible for the position difference calculation unit 23 to calculate, as position differences, differences between self-positions of the first to fourth cameras 41 to 44 that are estimated at a time when a vehicle C is stopped and self-positions of the first to fourth cameras 41 to 44 that are estimated at a time when a vehicle C is started to move.

Thereby, in the present embodiment, it is possible to readily detect that calculated position differences among the first to fourth cameras 41 to 44 are different values or are not zero, and hence, it is possible to reliably execute an image-capturing time lag detection process after detection or the like.

Additionally, calculated position differences among the first to fourth cameras 41 to 44 being different values is not limited to those at a time of starting of a vehicle C as described above. That is, for example, when a vehicle C is moving while being accelerated, when it is moving while being decelerated, when it is decelerated to stop, when it is accelerated or decelerated from a constant speed state, or the like, position differences among the first to fourth cameras 41 to 44 may be different values. Also in such a case, the position difference calculation unit 23 may output information that indicates calculated position differences to the image-capturing time lag detection unit 24 where a process to detect image-capturing time lags or the like is executed.

Thus, it is possible for the position difference calculation unit 23 to calculate, as a position difference, a difference between a self-position of a camera that is estimated before a vehicle C is accelerated or decelerated to move and a self-position of the camera that is estimated at a time when the vehicle C is accelerated or decelerated to move.

Thereby, in the present embodiment, it is possible to appropriately detect that calculated position differences among the first to fourth cameras 41 to 44 are different values or are not zero, depending on a wide range of driving situations of a vehicle C, and hence, it is possible to reliably execute an image-capturing time lag detection process after detection or the like.

Additionally, although position differences of the first to fourth cameras 41 to 44 as described above are, for example, vector quantities that include moving distances of respective cameras 40, moving directions (a moving direction) thereof, or the like, this is not limiting and they may be, for example, scalar quantities or the like.

The image-capturing time lag detection unit 24 detects image-capturing time lags that indicate image-capturing time lags of images among the first to fourth cameras 41 to 44, based on position differences of the first to fourth cameras 41 to 44 that are calculated by the position difference calculation unit 23.

Specifically, for example, the image-capturing time lag detection unit 24 divides position differences of the first to fourth cameras 41 to 44 that are calculated by the position difference calculation unit 23 by a speed at a time when a vehicle C is moving, so as to calculate image-capturing times of images in the first to fourth cameras 41 to 44, respectively.

Herein, as described above, a speed of a vehicle C that is used for calculation of an image-capturing time(s) may be a speed that is estimated in a next operation process (for example, at a point of time T3 in FIG. 1B). Specifically, in a case where a speed of a vehicle C is estimated in a next operation process, the position difference calculation unit 23 first calculates a position difference of a camera 40. A position difference of a camera 40 is a difference between self-positions of the camera 40 that are estimated in a previous process and a current process, and hence, the image-capturing time lag detection unit 24 divides a calculated position difference by a period of time from a previous process to a current process (for example, a frame time of a point of time T2 to a point of time T3 in FIG. 1B), so that it is possible to estimate a speed of a vehicle C.

Additionally, although it is assumed that a speed change of a vehicle C is comparatively small to move at a constant speed at a time of starting of the vehicle C and a speed that is estimated in a next operation process is used in the above, this is not limiting. That is, a configuration may be provided in such a manner that it is assumed that a vehicle C moves at a constant acceleration at a time of starting of the vehicle C and a speed of the vehicle C that is used for calculation of an image-capturing time is estimated from an acceleration that is estimated in a next operation process.

Then, the image-capturing time lag detection unit 24 detects image-capturing time lags among the first to fourth cameras 41 to 44, based on calculated image-capturing times of the first to fourth cameras 41 to 44. For example, the image-capturing time lag detection unit 24 detects time differences that are obtained by respectively subtracting image-capturing times of the first to fourth cameras 41 to 44 from a predetermined time that is a reference, as image-capturing time lags among the first to fourth cameras 41 to 44.

The correction unit 25 multiplies image-capturing time lags that are detected by the image-capturing time lag detection unit 24 by a current speed of a vehicle C to calculate amounts of correction of self-positions of the first to fourth cameras 41 to 44. Then, the correction unit 25 corrects self-positions that are estimated by the position estimation unit 22, based on calculated amounts of correction (see, for example, a point of time T4 in FIG. 1B).

Thereby, self-positions of the first to fourth cameras 41 to 44 are positions that are synchronized with one another, so that it is possible to reduce an influence of positional shifts that are caused by image-capturing time lags among the first to fourth cameras 41 to 44.

The creation unit 26 integrates information of images that are captured by the first to fourth cameras 41 to 44 to create map information, based on self-positions of the first to fourth cameras 41 to 44 that are corrected by the correction unit 25. Thus, self-positions of the first to fourth cameras 41 to 44 are synchronized by taking image-capturing time lags among the first to fourth cameras 41 to 44 into consideration, so that it is possible to improve accuracy of map information that is created by integrating information of images.

Furthermore, the creation unit 26 creates vehicle position information that indicates a position of a vehicle C, based on self-positions of the plurality of cameras 40 that are corrected by the correction unit 25. For example, arrangement position information that indicates arrangement or positions of the cameras 40 with respect to a vehicle C is preliminarily stored in the storage unit 30 and the creation unit 26 creates vehicle position information, based on the arrangement position information and corrected self-positions of the plurality of cameras 40 (the first to fourth cameras 41 to 44). Thus, in the present embodiment, self-positions of the cameras 40 where an influence of positional shifts that are caused by an image-capturing time lags among the plurality of cameras 40 is reduced by correction with amounts of correction as described above are used, so that it is possible to improve accuracy of vehicle position information that is created.

Additionally, as already described, for example, map information or vehicle position information with high accuracy is used in automated parking control that includes automatic valet parking, so that it is possible to automatically park a vehicle C appropriately.

3. Control Process of Image Processing Device According to First Embodiment

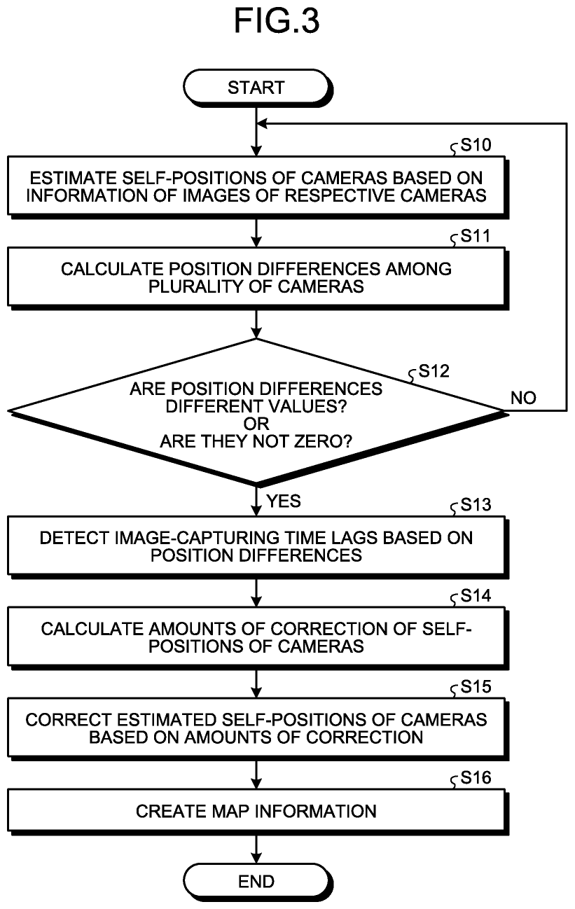

Next, specific process steps in the image processing device 10 will be explained by using FIG. 3. FIG. 3 is a flowchart illustrating process steps that are executed by the image processing device 10.

As illustrated in FIG. 3, the control unit 20 of the image processing device 10 respectively estimates self-positions of cameras 40 based on information of images of respective cameras 40 (step S10). Then, the control unit 20 calculates position differences between self-positions of the plurality of cameras 40 that are estimated in a previous process and self-positions of the corresponding plurality of cameras 40 that are estimated in a current process (step S11).

Then, the control unit 20 determines whether or not calculated position differences among the plurality of cameras 40 are different values or whether or not they are not zero (step S12). In a case where it is determined that position differences among the plurality of cameras 40 are not different values or remain zero (step S12, No), the control unit 20 returns to a process at step S10.

On the other hand, in a case where it is determined that position differences among the plurality of cameras 40 are different values or are not zero (step S12, Yes), the control unit 20 detects image-capturing time lags among the plurality of cameras 40 based on the position differences (step S13).

Then, the control unit 20 multiplies image-capturing time lags by a current speed of a vehicle C to calculate amounts of correction of self-positions of the cameras 40 (step S14). Subsequently, the control unit 20 corrects estimated self-positions of the plurality of cameras 40 based on calculated amounts of correction (step S15).

Then, the control unit 20 integrates information of images that are captured by the plurality of cameras 40 to create map information, based on corrected self-positions of the cameras 40 (step S16). Additionally, although the control unit 20 creates map information at step S16, this is not limiting, and for example, vehicle position information may be created based on corrected self-positions of the plurality of cameras 40.

As has been described above, the image processing device 10 according to a first embodiment includes the position estimation unit 22, the position difference calculation unit 23, and the image-capturing time lag detection unit 24. The position difference calculation unit 23 respectively estimates self-positions of the plurality of cameras 40 that are mounted on a vehicle C (an example of a movable body) and capture images of a periphery of the vehicle C. The position difference calculation unit 23 calculates, as a position difference, a difference between a first self-position of a camera that is estimated at a first point of time before a vehicle C is accelerated or decelerated to move and a second self-position of a camera 40 that is estimated at a second point of time when the vehicle C is accelerated or decelerated to move. The image-capturing time lag detection unit 24 detects an image-capturing time lag that indicates a lag of image-capturing time of an image among the plurality of cameras 40, based on a position difference that is calculated by the position difference calculation unit 23. Thereby, it is possible to detect a lag of image-capturing time among the plurality of cameras 40 that are mounted on a vehicle C.

Additionally, in the above, a difference between a self-position of a camera 40 that is estimated before a vehicle C is accelerated or decelerated to move and a self-position of the camera 40 that is estimated at a time when the vehicle C is accelerated or decelerated to move is calculated as a position difference and an image-capturing time lag is detected based on such a position difference. In other words, the image processing device 10 according to the present embodiment calculates, as a position difference, a difference between self-positions of a camera 40 that are estimated before and after a moving speed of a vehicle C is changed and an image-capturing time lag is detected based on such a position difference. Herein, a change of a moving speed may include a change of a speed and a direction (a movement vector).

That is, in the present embodiment, it is sufficient that it is possible to grasp, for example, a situation where a movement vector between images that are captured by an identical camera 40 (that may be in one frame or in a predetermined frame) is different among respective cameras, that is, a situation that is not movement at a constant speed, and a movement state thereof (for example, a speed or a direction of movement). Therefore, for example, it is possible for the image processing device 10 to detect movement (a movement state) of an image between captured images, calculate a position difference as described above based on the movement of an image, and detect an image-capturing time lag based on the position difference. Thereby, as already described, it is possible to detect a lag of image-capturing time among the plurality of cameras 40 that are mounted on a vehicle C.

4. Variation

Although the image processing device 10 in a first embodiment as described above detects an image-capturing time lag as position differences among the plurality of cameras 40 before and after starting of a vehicle C or the like are different values or are not zero, a state where position differences among the plurality of cameras 40 are different values or the like is not limited to that before and after starting of a vehicle C or the like.

That is, position differences among the plurality of cameras 40 are also different values depending on, for example, a steering angle of a vehicle C or movement of the vehicle C in a pitch direction or a roll direction thereof, so that position differences may be calculated by taking such a steering angle or the like into consideration to detect a lag of image-capturing time.

The image processing system 1 that includes the image processing device 10 according to a variation includes a steering angle sensor 60 or a gyro sensor 61 as indicated by an imaginary line in FIG. 2. The steering angle sensor 60 outputs a signal that indicates a steering angle of a vehicle C to the image processing device 10. Furthermore, the gyro sensor 61 outputs, for example, a signal that indicates an angle of a vehicle C in a pitch direction or a roll direction thereof to the image processing device 10.

In the image processing device 10, the acquisition unit 21 acquires, and outputs to the position difference calculation unit 23, a signal that is output from the steering angle sensor 60 or the gyro sensor 61. The position difference calculation unit 23 may calculate position differences of the plurality of cameras 40, depending on a steering angle that is obtained based on an output of the steering angle sensor 60. Furthermore, the position difference calculation unit 23 may calculate position differences of the plurality of cameras 40, depending on an angle in a pitch direction or a roll direction that is obtained based on an output of the gyro sensor 61.

Thereby, in a variation, it is possible to calculate position differences of the plurality of cameras 40 accurately, for example, even when a vehicle C is steered to drive on a curved road or even when a vehicle C is tilted by acceleration, deceleration, or the like of the vehicle C.

Additionally, although the image processing system 1 includes the steering angle sensor 60 and the gyro sensor 61 in a variation as described above, this is not limiting and a configuration may be provided so as to include one of the steering angle sensor 60 and the gyro sensor 61.

### Second Embodiment

5. Configuration of Image processing Device According to Second Embodiment

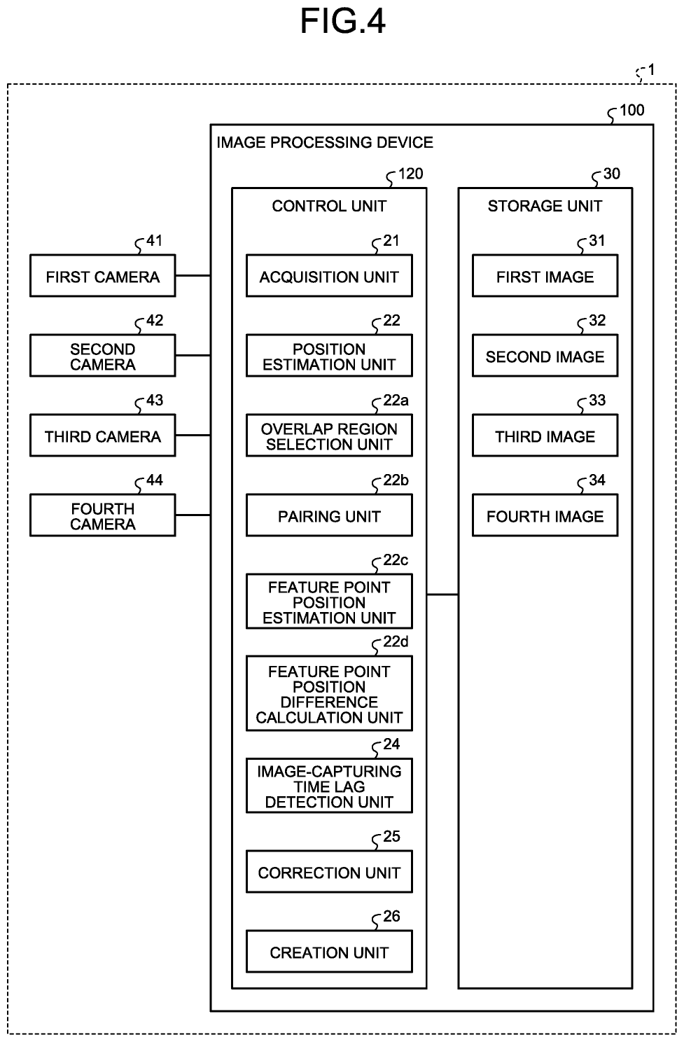

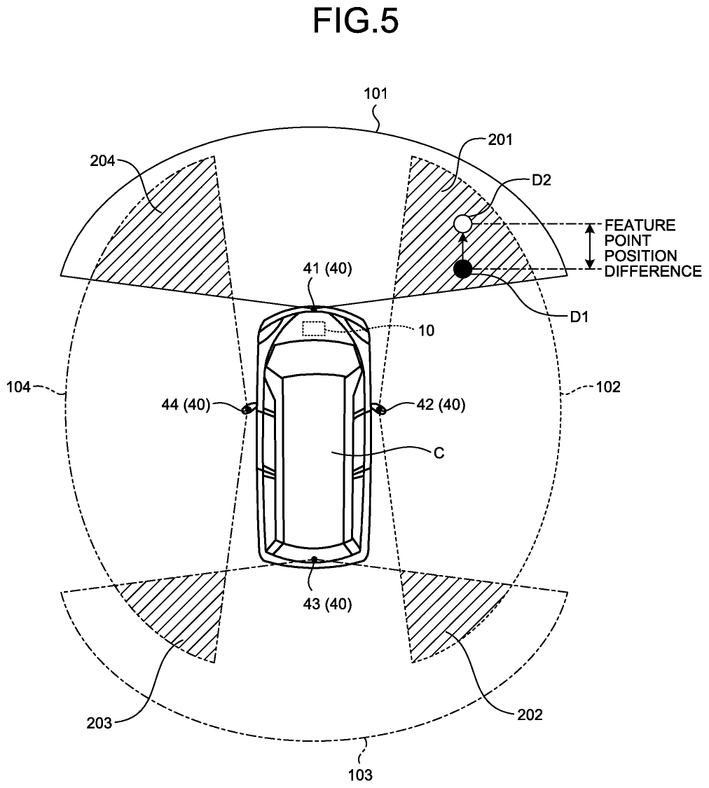

Next, a configuration of the image processing device 10 according to a second embodiment will be explained with reference to FIG. 4 and subsequent figures. FIG. 4 is a block diagram illustrating a configuration example of the image processing system 1 that includes the image processing device 10 according to a second embodiment. Furthermore, FIG. 5 is a diagram for explaining the image processing device 10 according to a second embodiment. Additionally, hereinafter, a component common to that of the first embodiment will be provided with an identical sign to omit an explanation(s) thereof.

As illustrated in FIG. 4 and FIG. 5, in a second embodiment, a position of a feature point that is present in an overlap region of images that are captured by the plurality of cameras 40 is compared between the cameras 40 to detect an image-capturing time lag(s).

As is explained specifically, the control unit 20 of the image processing device 10 according to a second embodiment includes the acquisition unit 21, the position estimation unit 22, an overlap region selection unit 22a, a pairing unit 22b, a feature point position estimation unit 22c, a feature point position difference calculation unit 22d, the image-capturing time lag detection unit 24, the correction unit 25, and the creation unit 26.

The overlap region selection unit 22a selects an overlap region(s) in a plurality of images that are captured by the plurality of cameras 40, that is, the first to fourth cameras 41 to 44. Herein, an overlap region(s) will be explained with reference to FIG. 5.

As illustrated in FIG. 5, the first to fourth cameras 41 to 44 have a comparatively wide angle of view, so that a plurality of captured images partially overlap with those of adjacent cameras 40. For example, a first image-capturing range 101 of the first camera 41 and a second image-capturing range 102 of the second camera 42 partially overlap to form an overlap region 201.

Furthermore, the second image-capturing range 102 of the second camera 42 and a third image-capturing range 103 of the third camera 43 partially overlap to form an overlap region 202. Furthermore, the third image-capturing range 103 of the third camera 43 and a fourth image-capturing range 104 of the fourth camera 44 partially overlap to form an overlap region 203. Furthermore, the fourth image-capturing range 104 of the fourth camera 44 and the first image-capturing range 101 of the first camera 41 partially overlap to form an overlap region 204.

The overlap region selection unit 22a image-processes information of images that are captured by respective cameras 40 and selects overlap regions 201 to 204 that have a feature point(s) such as a target(s) (for example, another vehicle, a pole, or the like) from the plurality of overlap regions 201 to 204 based on a result of image processing. Additionally, in an example as illustrated in FIG. 5, it is assumed that a feature point D1 is detected in the overlap region 201 in the first image-capturing range 101 of the first camera 41 and a feature point D2 is detected in the overlap region 201 in the second image-capturing range 102 of the second camera 42.

The pairing unit 22b pairs (or combines) both feature points that are estimated to be identical feature points among feature points that are present in an overlap region of adjacent cameras 40. For example, the pairing unit 22b pairs both feature points where a degree of similarity (or a similarity) between feature amounts of the feature points is comparatively high or both feature points that provide a minimum error in a position point distribution. Additionally, in an example of FIG. 5, it is assumed that a feature point D1 and a feature point D2 are paired.

The feature point position estimation unit 22c respectively estimates positions of paired feature points, based on information of images that are captured by cameras 40. In an example of FIG. 5, a position of a feature point D1 is estimated based on information of an image that is captured by the first camera 41 and a position of a feature point D2 is estimated based on information of an image that is captured by the second camera 42.

The feature point position difference calculation unit 22d calculates, as a feature point position difference (a pair distance difference), a difference between positions of paired feature points that are estimated by the feature point position estimation unit 22c. For example, in an example as illustrated in FIG. 5, the feature point position difference calculation unit 22d calculates, as a feature point position difference, a difference between a position of a feature point D1 that is estimated in an image that is captured by the first camera 41 (an example of one camera) that captures an image that has the overlap region 201 and a position of a feature point D2 that is estimated in an image that is captured by the second camera 42 (an example of another camera).

Such a feature point position difference is proportional to a speed of a vehicle C. Therefore, the image-capturing time lag detection unit 24 divides a feature point position difference by a current speed of a vehicle C to detect an image-capturing time lag. Additionally, in a case where a speed of a vehicle C is zero, a feature point position difference, per se, is absent or substantially absent, so that the image-capturing time lag detection unit 24 may execute no process to detect an image-capturing time lag.

Thus, in a second embodiment, a calculated feature point position difference is used, so that it is possible to detect image-capturing time lags among the plurality of cameras 40.

As described above, as image-capturing time lags among the plurality of cameras 40 are detected, the correction unit 25 corrects self-positions that are estimated by the position estimation unit 22, similarly to the first embodiment. For example, the correction unit 25 multiplies image-capturing time lags that are detected by the image-capturing time lag detection unit 24 by a current speed of a vehicle C to calculate amounts of correction of self-positions of the plurality of cameras 40. Then, the correction unit 25 corrects self-positions that are estimated by the position estimation unit 22 based on calculated amounts of correction.

Thereby, self-positions of the plurality of cameras 40 are positions that are synchronized with one another, so that it is possible to reduce an influence of positional shifts that are caused by image-capturing time lags among the plurality of cameras 40.

The creation unit 26 integrates information of images that are captured by the plurality of cameras 40 to create map information, based on self-positions of the plurality of cameras 40 that are corrected by the correction unit 25. Thus, self-positions of the plurality of cameras 40 are synchronized by taking image-capturing time lags among the plurality of cameras 40 into consideration, so that it is possible to improve accuracy of map information that is created by integrating information of images.

Furthermore, the creation unit 26 creates vehicle position information that indicates a position of a vehicle C, based on self-positions of the plurality of cameras 40 that are corrected by the correction unit 25. Thus, in a second embodiment, self-positions of the cameras 40 where an influence of positional shifts that are caused by image-capturing time lags among the plurality of cameras 40 is reduced by correction with amounts of correction as described above are used, similarly to the first embodiment, so that it is possible to improve accuracy of vehicle position information that is created.

6. Control Process of Image Processing Device According to Second Embodiment

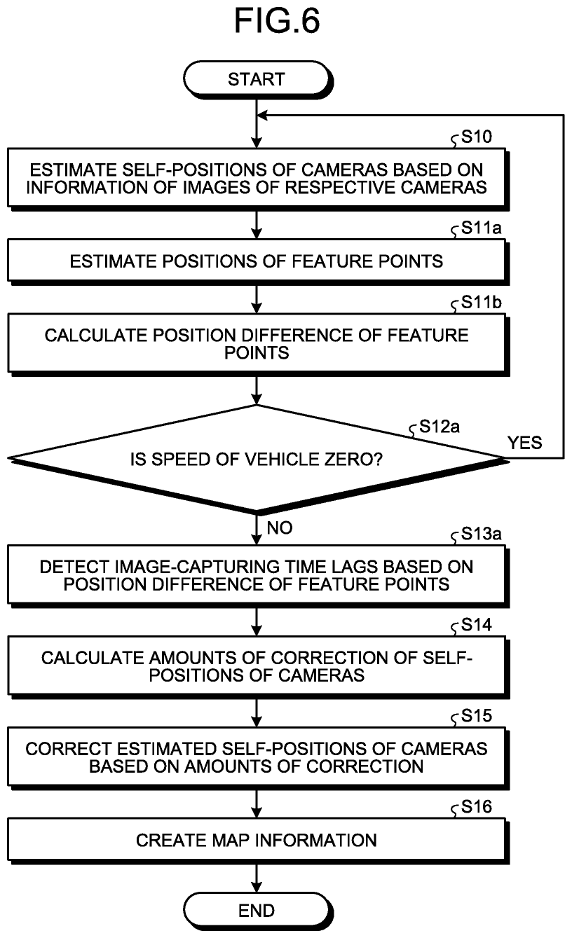

Next, specific process steps in the image processing device 10 according to a second embodiment will be explained by using FIG. 6. FIG. 6 is a flowchart illustrating process steps that are executed by the image processing device 10 according to a second embodiment.

As illustrated in FIG. 6, the control unit 20 of the image processing device 10 estimates feature point positions of feature points in the overlap regions 201 to 204 (step S11a) after a process at step S10. Then, the control unit 20 calculates a feature point position difference between estimated positions of feature points (step S11b).

Then, the control unit 20 determines whether or not a speed of a vehicle C is zero (step S12a). In a case where it is determined that a speed of a vehicle C is zero (step S12a, Yes), the control unit 20 returns to a process at step S10.

On the other hand, in a case where it is determined that a speed of a vehicle C is not zero (step S12a, No), the control unit 20 detects an image-capturing time lag among the plurality of cameras 40 based on a feature point position difference (step S13a). Additionally, processes at step S14 and subsequent steps are similar to those of the first embodiment, so that an explanation(s) thereof will be omitted.

As described above, the image processing device 10 according to the second embodiment includes the feature point position estimation unit 22c, the feature point position difference calculation unit 22d, and the image-capturing time lag detection unit 24. The feature point position estimation unit 22c estimates positions of feature points that are present in an overlap region of a plurality of images that are captured by the plurality of cameras 40 that are mounted on a vehicle C (an example of a movable body). The feature point position difference calculation unit 22d calculates, as a feature point position difference, a difference between a position of a feature point that is estimated in an image that is captured by one camera 40 among the plurality of cameras 40 that capture images that have an overlap region(s) and a position of a feature point that is estimated in an image that is captured by another camera 40. The image-capturing time lag detection unit 24 detects an image-capturing time lag that indicates a lag of image-capturing time of an image among the plurality of cameras 40, based on a feature point position difference that is calculated by the feature point position difference calculation unit 22d. Thereby, it is possible to detect a lag of image-capturing time among the plurality of cameras 40 that are mounted on a vehicle C.

### Third Embodiment

7. Image Processing Device According to Third Embodiment

Next, the image processing device 10 according to a third embodiment will be explained. A configuration example of the image processing system 1 that includes the image processing device 10 according to a third embodiment is similar to a configuration example of the image processing system 1 that includes the image processing device 10 according to the first embodiment (see FIG. 2).

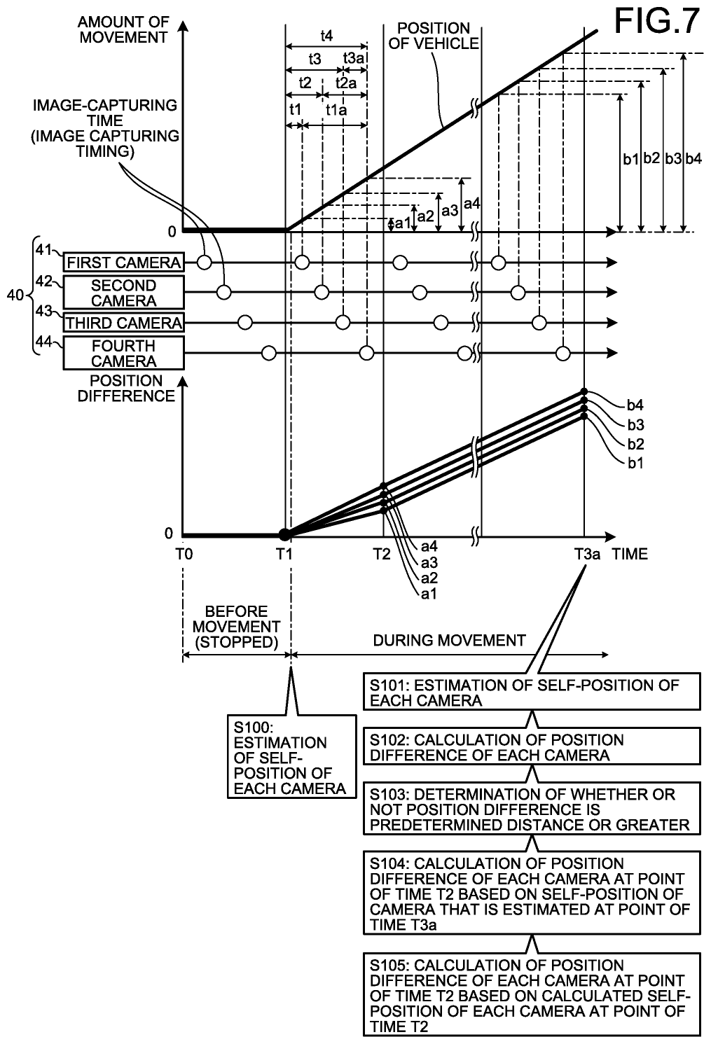

Hereinafter, the image processing device 10 according to a third embodiment will be explained with reference to FIG. 2, FIG. 7, and subsequent figures. FIG. 7 is a diagram for explaining an image processing method according to a third embodiment.

As illustrated in FIG. 2 and FIG. 7, the position difference calculation unit 23 according to a third embodiment calculates a position difference of a camera 40 at a point of time T2 when a vehicle C is moving. As described above, a position difference of a camera 40 at a point of time T2 is a difference between a self-position of the camera 40 at a point of time T1 and a self-position of the camera 40 at the point of time T2.

Herein, the position difference calculation unit 23 according to a third embodiment takes a camera characteristic such as a resolution of a camera 40 into consideration and calculates a self-position of the camera 40 at a point of time T2 based on a self-position of the camera 40 that is estimated at a point of time T3 when a predetermined frame time has passed since the point of time T2.

Thereby, in a third embodiment, it is possible to calculate a position difference of a camera 40 at a point of time T2 accurately, and as a result, it is also possible to detect a lag of image-capturing time among the plurality of cameras 40 accurately. Additionally, a point of time T3 as described above is an example of a third point of time and a self-position of a camera 40 that is estimated at the point of time T3 is an example of a third self-position.

Hereinafter, calculation of a position difference of a camera 40 at a point of time T2 will be focused and explained in detail. As illustrated in FIG. 7, the position estimation unit 22 (see FIG. 2) of the image processing device 10 respectively acquires information of images from the first to fourth cameras 14 to 44 at a point of time T1, and estimates self-positions of the first to fourth cameras 41 to 44, based on acquired information of images (step S100).

Subsequently, the position estimation unit 22 also respectively acquires information of images from the first to fourth cameras 41 to 44, for example, at a point of time T3 when a vehicle C is moving, and estimates self-positions of the first to fourth cameras 41 to 44, based on acquired information of images (step S101). Additionally, although an example of FIG. 7 illustrates that self-positions are estimated at a point of time T3 for sake of simplicity of illustration, it is assumed that the image processing device 10 estimates self-positions at each of process timings such as a point of time T2 and calculates position differences of the first to fourth cameras 41 to 44 based on estimated self-positions.

Then, the position difference calculation unit 23 (see FIG. 2) of the image processing device 10 calculates position differences of the first to fourth cameras 41 to 44 at a point of time T3a (step S102). Additionally, in FIG. 7, a position difference of a camera 40 at a point of time T3a indicates a difference between a self-position of the camera 40 that is estimated at a point of time t1 when a vehicle C is stopped and a self-position of the camera 40 that is estimated in a current process (herein, a point of time T3).

Specifically, the position difference calculation unit 23 calculates, as a position difference of the first camera 41, a difference b1 between a self-position of the first camera 41 that is estimated in a process at a point of time T1 and a self-position of the first camera 41 that is estimated in a process at a point of time T3a. Furthermore, the position difference calculation unit 23 calculates, as a position difference of the second camera 42, a difference b2 between a self-position of the second camera 42 that is estimated in a process at a point of time T1 and a self-position of the second camera 42 that is estimated in a process at a point of time T3a.

Furthermore, the position difference calculation unit 23 calculates, as a position difference of the third camera 43, a difference b3 between a self-position of the third camera 43 that is estimated in a process at a point of time T1 and a self-position of the third camera 43 that is estimated in a process at a point of time T3a. Furthermore, the position difference calculation unit 23 calculates, as a position difference of the fourth camera 44, a difference b4 between a self-position of the fourth camera 44 that is estimated in a process at a point of time T1 and a self-position of the fourth camera 44 that is estimated in a process at a point of time T3a.

Subsequently, the position difference calculation unit 23 determines whether or not a calculated position difference of each camera 40 is a predetermined distance or greater (step S103). For example, the position difference calculation unit 23 may determine whether or not all position differences among position differences of respective cameras 40 are a predetermined distance or greater or may determine whether or not a part of position differences among position differences of respective cameras 40 is a predetermined distance or greater.

Such a predetermined distance is calculated based on a camera characteristic. For example, a predetermined distance is calculated based on a resolution of a camera 40. Specifically, a predetermined distance is set at a value that is greater than a resolution of a camera 40, more specifically, a value that is approximately several times to several tens of times (for example, 10 times) the resolution.

A predetermined distance is set as described above, so that step 5103 is also referred to as a process to determine whether or not a process timing at a point of time T3a is a process timing when it is possible to execute calculation of a position difference of a camera 40 or estimation of a self-position of the camera 40 accurately when the camera 40 that has a predetermined resolution (a camera characteristic) is used.

Furthermore, a point of time that is able to be a process timing when it is possible to execute estimation of a self-position of a camera 40 accurately (herein, a point of time T3a) is a point of time when a predetermined frame time has passed since a point of time T2 that is a first process timing when a vehicle C starts to move (a second point of time). Additionally, although a predetermined frame time is a frame time that corresponds to a plurality of frames of a camera 40, this is not limiting and it may be a frame time that corresponds to one frame.

In a case where it is determined that a position difference of a camera 40 is a predetermined distance or greater, the position difference calculation unit 23 calculates a self-position of each camera 40 at a point of time T2, based on a self-position of the camera 40 that is estimated at a point of time T3a (step S104). That is, at a process timing when a position difference of a camera 40 is a predetermined distance or greater and it is possible to execute estimation of a self-position of the camera 40 accurately (herein, a point of time T3a), the position difference calculation unit 23 calculates a self-position of each camera 40 at a point of time T2 by using a self-position of the camera 40 that is estimated at a point of time T3a and reaching back to the point of time T2.

Specifically, the position difference calculation unit 23 first calculates an amount of movement of a vehicle C from a point of time T2 to a point of time T3a. For example, the position difference calculation unit 23 multiplies a frame time of a camera 40 from a point of time T2 to a point of time T3a (in other words, a period of time for a plurality of frames of a camera 40) by a speed of a vehicle C to calculate an amount of movement of the vehicle C from the point of time T2 to the point of time T3a.

Additionally, for example, a speed of a vehicle C that is used for calculation of an amount of movement of the vehicle C as described above may be a vehicle speed that is estimated at each process timing from a point of time T2 to a point of time T3 (for example, an average vehicle speed) or may be a vehicle speed that is obtained from a non-illustrated vehicle speed sensor (for example, an average vehicle speed).

Then, the position difference calculation unit 23 subtracts an amount of movement of a vehicle C from a self-position of a camera 40 that is estimated at a point of time T3a to calculate a self-position of the camera 40 at a point of time T2.

Thus, the position difference calculation unit 23 according to a third embodiment calculates an amount of movement of a vehicle C from a point of time T2 to a point of time T3a and subtracts the amount of movement of a vehicle C from a self-position of a camera 40 that is estimated at the point of time T3a to calculate a self-position of the camera 40 at the point of time T2. Thereby, in a third embodiment, it is possible to calculate a self-position of a camera 40 at a point of time T2 accurately.

Then, the position difference calculation unit 23 calculates a position difference of each camera 40 at a point of time T2, based on a calculated self-position of the camera 40 at the point of time T2 (step S105).

Specifically, the position difference calculation unit 23 calculates, as a position difference of the first camera 41 at a point of time T2, a difference a1 between a self-position of the first camera 41 that is estimated at a point of time T1 and a self-position of the first camera 41 at the point of time T2 that is calculated based on a self-position of the first camera 41 that is estimated at a point of time T3a.

Furthermore, the position difference calculation unit 23 calculates, as a position difference of the second camera 42 at a point of time T2, a difference a2 between a self-position of the second camera 42 that is estimated at a point of time T1 and a self-position of the second camera 42 at the point of time T2 that is calculated based on a self-position of the second camera 42 that is estimated at a point of time T3a.

Furthermore, the position difference calculation unit 23 calculates, as a position difference of the third camera 43 at a point of time T2, a difference a3 between a self-position of the third camera 43 that is estimated at a point of time T1 and a self-position of the third camera 43 at the point of time T2 that is calculated based on a self-position of the third camera 43 that is estimated at a point of time T3a.

Furthermore, the position difference calculation unit 23 calculates, as a position difference of the fourth camera 44 at a point of time T2, a difference a4 between a self-position of the fourth camera 44 that is estimated at a point of time T1 and a self-position of the fourth camera 44 at the point of time T2 that is calculated based on a self-position of the fourth camera 44 that is estimated at a point of time T3a.

Thus, the position difference calculation unit 23 according to a third embodiment calculates a self-position of a camera 40 at a point of time T2, based on a self-position of the camera 40 that is estimated at a point of time T3a when a predetermine frame time has passed since the point of time T2. Then, the position difference calculation unit 23 according to a third embodiment calculates a position difference of a camera 40 at a point of time T2, based on a calculated self-position of the camera 40 at the point of time T2.

Thereby, in a third embodiment, it is possible to calculate a self-position of a camera 40 at a point of time T2 by using a self-position of the camera 40 that is estimated at a process timing when it is possible to execute estimation of a self-position of the camera 40 accurately (herein, a point of time T3a) while, for example, a camera characteristic such as a resolution of the camera 40 is taken into consideration, and hence, it is possible to calculate a position difference of the camera 40 at the point of time T2 accurately.

Additionally, although illustration is omitted in FIG. 7, in a third embodiment, a process to detect an image-capturing time lag among the plurality of cameras 40 based on a calculated position difference, a process to calculate an amount of correction based on the image-capturing time lag to correct the self-position, a process to create map information or vehicle position information based on a corrected self-position, and the like are executed, similarly to the first embodiment.

Additionally, although the position difference calculation unit 23 estimates a self-position of a camera 40 at a point of time T3a, calculates a self-position of the camera 40 at a point of time T2 based on an estimated self-position of the camera 40 at the point of time T3a, and calculates a position difference of the camera 40 at the point of time T2 based on a calculated self-position of the camera 40 at the point of time T2 in the above, this is not limiting.

That is, for example, the position difference calculation unit 23 calculates a position difference of a camera 40 at a point of time T3a based on a self-position of the camera 40 that is estimated at the point of time T3a. Then, the position difference calculation unit 23 may subtract an amount of movement of a vehicle C from a point of time T2 to a point of time T3a from a position difference of a camera 40 at the point of time T3a to calculate a position difference of the camera 40 at the point of time T2.

8. Control Process of Image Processing Device According to Third Embodiment

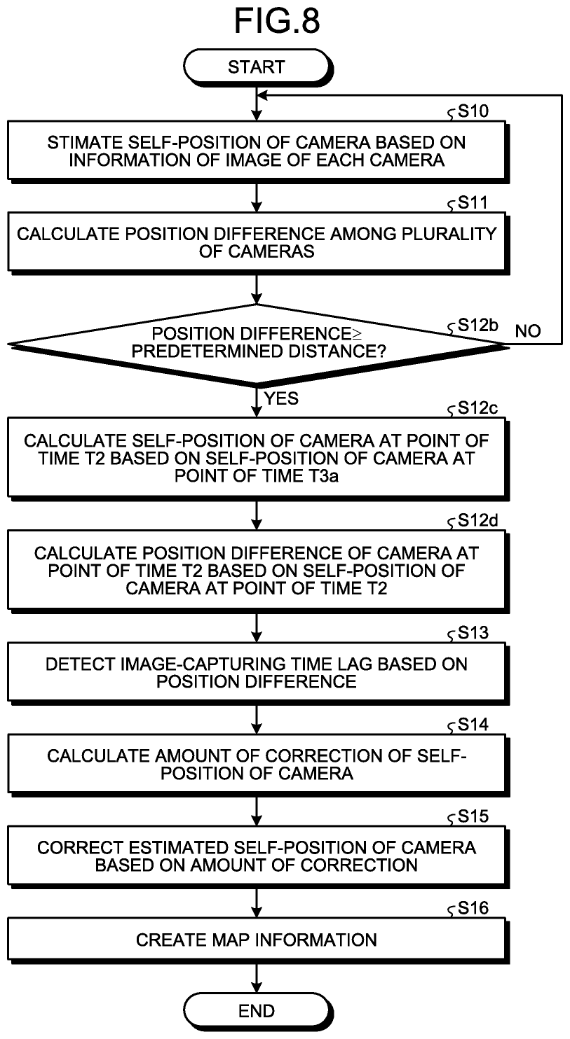

Next, specific process steps in the image processing device 10 according to a third embodiment will be explained by using FIG. 8. FIG. 8 is a flowchart illustrating process steps that are executed by the image processing device 10 according to a third embodiment.

As illustrated in FIG. 8, the control unit 20 of the image processing device 10 determines whether or not a position difference of a camera 40 is a predetermined distance or greater (step S12b) after a process at step S11.

Additionally, although illustration is not provided, as the control unit 20 detects that position differences are different values at a time of starting or the like, similarly to step S12 in FIG. 3, after a position difference of a camera 40 is calculated at step S11, a self-position of the camera 40 immediately prior thereto (on a stopped vehicle) is stored as a reference value. At step S12b, a difference between such a reference value and a self-position of a camera 40 that is estimated in a current process is used as a position difference.

In a case where it is determined that a position difference of a camera 40 is not a predetermined distance or greater (step S12b, No), in other words, in a case where it is determined that a position difference of the camera 40 is less than the predetermined distance, the control unit 20 returns to a process at step S10.

On the other hand, in a case where it is determined that a position difference of a camera 40 is a predetermined distance or greater (step S12b, Yes), the control unit 20 calculates a self-position of the camera 40 at a point of time T2 (see FIG. 7), based on a self-position of the camera 40 that is estimated at a point of time T3a (see FIG. 7) when a position difference of the camera 40 is a predetermined distance or greater (step S12c).

Then, the control unit 20 calculates a position difference of a camera 40 at a point of time T2 based on a self-position of the camera 40 at the point of time T2 (step S12d). For example, the control unit 20 calculates, as a position difference of a camera 40 at a point of time T2, a difference between a self-position of the camera 40 that is estimated at a point of time T1 (see FIG. 7) and a self-position of the camera 40 at the point of time T2 that is calculated based on a self-position of the camera 40 that is estimated at a point of time T3a. Additionally, processes at step S13 and subsequent steps are similar to those of the first embodiment, so that an explanation(s) thereof will be omitted.

Additionally, in each embodiment as described above, for example, when map information where a lag of image-capturing time is corrected is created, image processing such as movement, deformation, or scaling may appropriately be applied to information of an image(s) that is/are utilized for creation of the map information, depending on a positional shift. Thereby, it is possible to provide a natural image, for example, when a user views created map information.

Additionally, although a specific example is illustrated for a value that is set at a predetermined distance in a third embodiment as described above, this is not limiting and any value may be set at.

According to a disclosed embodiment, it is possible to detect a lag of image-capturing time among a plurality of cameras that are mounted on a movable body.

An additional effect(s) or variation(s) can readily be derived by a person(s) skilled in the art. Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. An image processing device, comprising:
a position estimation unit that respectively estimates self-positions of a plurality of cameras that are mounted on a movable body and capture images of a periphery of the movable body;
a position difference calculation unit that calculates, as a position difference, a difference between a first self-position of a camera that is estimated at a first point of time before the movable body is accelerated or decelerated to move and a second self-position of the camera that is estimated at a second point of time when the movable body is accelerated or decelerated to move; and
an image-capturing time lag detection unit that detects an image-capturing time lag that indicates a lag of image-capturing time of an image among the plurality of cameras based on the position difference that is calculated by the position difference calculation unit.

2. The image processing device according to claim 1, comprising
a correction unit that multiplies the image-capturing time lag that is detected by the image-capturing time lag detection unit by a current speed of the movable body to calculate an amount of correction of a self-position of a camera and corrects the self-position that is estimated by the position estimation unit based on the calculated amount of correction.

3. The image processing device according to claim 2, comprising
a creation unit that integrates information of images that are captured by the plurality of cameras to create map information of a periphery of the movable body, based on a self-position of a camera that is corrected by the correction unit.

4. The image processing device according to claim 2, comprising
a creation unit that creates movable body position information that indicates a position of the movable body based on self-positions of the plurality of cameras that are corrected by the correction unit.

5. The image processing device according to claim 1, wherein the image-capturing time lag detection unit divides the position difference that is calculated by the position difference calculation unit by a speed at a time when the movable body is accelerated or decelerated to move to calculate image-capturing times of images in the plurality of cameras respectively and detects the image-capturing time lag among the plurality of cameras based on the calculated image-capturing times of the plurality of cameras.

6. The image processing device according to claim 1, wherein the position difference calculation unit calculates, as the position difference, a difference between a self-position of a camera that is estimated when the movable body is stopped and a self-position of the camera that is estimated when the movable body is started to move.

7. The image processing device according to claim 1, wherein the position difference calculation unit calculates the second self-position based on a third self-position of a camera that is estimated at a third point of time when a predetermined frame time has passed since the second point of time.

8. The image processing device according to claim 7, wherein the position difference calculation unit calculates an amount of movement of the movable body from the second point of time to the third point of time and subtracts the amount of movement of the movable body from the third self-position to calculate the second self-position.

9. An image processing device, comprising:
a position estimation unit that respectively estimates self-positions of a plurality of cameras that are mounted on a movable body and capture images of a periphery of the movable body;
a position difference calculation unit that calculates, as a position difference, a difference between self-positions of a camera that are estimated before and after a movement speed of the movable body is changed; and
an image-capturing time lag detection unit that detects an image-capturing time lag that indicates a lag of image-capturing time of an image among the plurality of cameras based on the position difference that is calculated by the position difference calculation unit.

10. An image processing device, comprising:
a feature point position estimation unit that estimates a position of a feature point that is present in an overlap region of a plurality of images that are captured by a plurality of cameras that are mounted on a movable body;
a feature point position difference calculation unit that calculates, as a feature point position difference, a difference between a position of a feature point that is estimated on an image that is captured by one camera among a plurality of cameras that capture images that have the overlap region and a position of a feature point that is estimated on an image that is captured by another camera; and
an image-capturing time lag detection unit that detects an image-capturing time lag that indicates a lag of image-capturing time of an image among the plurality of cameras based on the feature point position difference that is calculated by the feature point position difference calculation unit.

11. The image processing device according to claim 10, comprising
a correction unit that multiplies the image-capturing time lag that is detected by the image-capturing time lag detection unit by a current speed of the movable body to calculate an amount of correction of a self-position of a camera and corrects the self-position of the camera based on the calculated amount of correction.

12. The image processing device according to claim 11, comprising
a creation unit that integrates information of images that are captured by the plurality of cameras to create map information of a periphery of the movable body based on a self-position of a camera that is corrected by the correction unit.

13. The image processing device according to claim 11, comprising
a creation unit that creates movable body position information that indicates a position of the movable body based on self-positions of the plurality of cameras that are corrected by the correction unit.

14. An image processing method, comprising:
respectively estimating self-positions of a plurality of cameras that are mounted on a movable body and capture images of a periphery of the movable body;
calculating, as a position difference, a difference between a first self-position of a camera that is estimated at a first point of time before the movable body is accelerated or decelerated to move and a second self-position of the camera that is estimated at a second point of time when the movable body is accelerated or decelerated to move; and
detecting an image-capturing time lag that indicates a lag of image-capturing time of an image among the plurality of cameras based on the calculated position difference.

15. An image processing method, comprising:
respectively estimating self-positions of a plurality of cameras that are mounted on a movable body and capture images of a periphery of the movable body;
calculating, as a position difference, a difference between self-positions of a camera that are estimated before and after a movement speed of the movable body is changed; and
detecting an image-capturing time lag that indicates a lag of image-capturing time of an image among the plurality of cameras based on the calculated position difference.

16. An image processing method, comprising:
estimating a position of a feature point that is present in an overlap region of a plurality of images that are captured by a plurality of cameras that are mounted on a movable body;
calculating, as a feature point position difference, a difference between a position of a feature point that is estimated on an image that is captured by one camera among a plurality of cameras that capture images that have the overlap region and a position of a feature point that is estimated on an image that is captured by another camera; and
detecting an image-capturing time lag that indicates a lag of an image-capturing time of an image among the plurality of cameras based on the calculated feature point position difference.
